(19) United States
(12) Patent Application Publication
(10) Pub. No.: US 2024/0338987 A1
(43) Pub. Date: Oct. 10, 2024

(54) COMPUTERIZED SYSTEMS AND METHODS FOR DYNAMIC AUTOMATION OF SECURITY FEATURES FOR A LOCATION

(71) Applicant: PLUME DESIGN, INC., Palo Alto, CA (US)

(72) Inventors: Miro SAMARDZIJA, Mountain View, CA (US); Liem Hieu Dinh VO, San Jose, CA (US)

(21) Appl. No.: 18/296,115

(22) Filed: Apr. 5, 2023

(51) Int. Cl. G07C 9/37; G07C 9/00

(52) U.S. Cl. CPC G07C 9/37; G07C 9/00896

(57) ABSTRACT

Disclosed are systems and methods that provide a novel framework for centralized management of a location based on detected, analyzed and monitored behaviors that can be compared against real-world activities to determine whether to toggle the operational modes of a components operating at/around the location. The disclosed framework can operate via an integrated, personalized configuration that enables the collective management of a location based on the sensors available from each device operating therein. The framework can operate as a centralized station or hub that can collect sensor data from smart devices/appliances in/around the location. This data can be utilized to generate and/or determine patterns of activity of a user, which can be leveraged to automatically and dynamically toggle a status of entry-points and associated smart devices associated therewith based on the real-time activity occurring in/around the location.

### FIELD OF THE DISCLOSURE

The present disclosure is generally related to a location monitoring system, and more particularly, to a decision intelligence (DI)-based computerized framework for automatically and dynamically securing a location based on real-time detected events.

### BACKGROUND

Conventional smart homes include features that enable user residents to gain access to their homes. For example, rather than using traditional keys to enter a home, existing systems can leverage cameras, fobs, smart phones, and the like to identify whether a user is proximate an entryway of the home in order to discern whether access is to be granted to that user.

### SUMMARY OF THE DISCLOSURE

However, conventional smart homes are not focused on securing the home (or locking the home) once the user is inside the home. That is, the sole focus of conventional smart home systems is to enable entry. This, however, evidences a technical and security-based shortcoming in the applicability of existing systems.

To that end, according to some embodiments, the disclosed systems and methods provide a novel computerized security framework that addresses current shortcomings in the field, among others, by providing security features that leverage learned behaviors of occupants of a location against current, real-time activities at the location to manage how the location is protected.

In some embodiments, as discussed herein, a location can refer to any type of definable and/or confined geographic and/or physical area for which a smart home and/or security system can be applied, such as, not limited to, a home, office, building, yard and the like. Accordingly, as discussed herein, the disclosed framework provides non-native functionality to a smart home system (and/or security system) for trained learning of users' habits and routines, which can trigger proactive decisions related to securing the location.

For example, as discussed below, entry-points to a location, which can include, but are not limited to, doors, windows, gates, and the like can be unlocked and locked automatically based on determined intelligence pattern indicating predicted actions of the users occupying and/or visiting the location. In some embodiments, the disclosed framework can operate in relation to a smart security system, where not only can entry-points to the location be locked/unlocked, the system as a whole can be “armed” and/or “disarmed” based on the determined intelligence patterns of the users in/around the location.

In some embodiments, the disclosed framework can provide Internet of Things (IoT)-based mechanisms that enable the collective management of a location based on the sensors available from each device and smart device operating therein. For example, the disclosed framework can operate as a centralized security panel(s) that can collect sensor data from smart devices/appliances in/around the location. For example, such sensor data and/or devices can include, but are not limited to, time-of-flight (ToF) sensors, motion detectors, door and window contacts, heat and smoke detectors, carbon monoxide (CO₂) detectors, passive infrared (PIR) sensors, lights, smart locks, garage doors, smart appliances (e.g., thermostat, refrigerator, television, personal assistants (e.g., Alexa®, Nest®, for example)), smart phones, smart watches, smart rings or other wearables, tablets, personal computers, and the like, and some combination thereof.

For example, biometrics (or vitals, used interchangeably) of a user can be leveraged to not only determine patterns of their behavior, but can also provide indicators as to current actions (or non-action) of the user, which can be utilized by the disclosed framework to toggle lock/unlock operations for a smart home, as discussed herein.

Thus, each sensor/detector in/around a location can be utilized to track user movements for purposes of developing a behavioral pattern(s), which can be compared against real-time tracked movements of users, and serve as a basis for managing how the location can be secured. Accordingly, in some embodiments as discussed herein, as users move in, around, about and out a location, their movements can trigger the location to be secured (e.g., close and/or lock certain doors, for example), unsecured (e.g., unlock a door or particular door, for example), and/or some combination thereof.

For example, as discussed in more detail below, it is understood that a user typically gets home from work at 7:30 PM, and after eating diner, the user falls asleep in her bedroom at/around 10 PM. This information can be collected, analyzed and learned via the disclosed framework's analysis and compilation of behavior patterns from associated sensors of the location, as discussed infra. Upon a time proximate to 10 PM occurring (e.g., 3 minutes to the determined time period, for example), the disclosed framework detects that while the user is in his bedroom, they are not moving, which lends to support the behavior that the user is asleep. However, the front door of the location remains unlocked. Therefore, based on the computational intelligence that the user is asleep, the disclosed framework can automatically trigger an instruction to the application program interface (API) of the smart door lock of the front door to engage the locking mechanism. Thus, the user's security is maintained, which provides a “closed-loop” feature-set not currently available from existing smart home technologies.

According to some embodiments, a method is disclosed for a DI-based computerized framework for deterministically controlling real-world and digital security components at a location based on real-time detected events. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for deterministically controlling real-world and digital security components at a location based on real-time detected events.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 illustrates an exemplary workflow according to some embodiments of the present disclosure;

FIG. 5 depicts an exemplary implementation of an architecture according to some embodiments of the present disclosure;

FIG. 6 depicts an exemplary implementation of an architecture according to some embodiments of the present disclosure; and

FIG. 7 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or.” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, the disclosed framework provides an integrated, personalized management of a user's safety within a location via an applied security framework. As discussed herein, the disclosed systems and methods provide a centralized management of a user's location based on detected, analyzed and monitored behaviors that can be compared against learned real-world activities to determine when/how to secure smart home components of the location.

By way of a non-limiting example, according to some embodiments, a user who typically closes their garage door when/after they park their car may forget to do so (e.g., they go to sleep and/or go for a walk, for example, leaving the door open, as well as access to their home open). The disclosed systems and methods herein can determine that the garage door i) is open and ii) should be closed, which can be based on learned and/or detected activity of the user, and automatically trigger is closure. In some embodiments, as provided below, such instructions to close the garage can be triggered and/or originate from a web-based application (e.g., executing on a cloud system); and/or in some embodiments, such instructions can be provided from an application executing on a user's device, which can be a smart phone, or a wearable device (e.g., a smart ring, for example), as discussed in more detail below.

According to some embodiments, the discussion herein may focus on embodiments related to a user or users' home; however, it should not be construed as limiting, as one of skill in the art would understand that the disclosed security components for automatically securing a location can be applied to any type of location which can be fit with a smart security system without departing from the scope of the instant disclosure. For example, an office building can have its doors auto-locked upon detection that i) the last office employee has exited the building, and ii) the night-cleaning staff has finished their rounds.

Moreover, embodiments exist where the disclosed framework can be applied to appliances, furniture, safes and/or any other type of structure or apparatus that is capable of being secured by a smart device. For example, an employees desk can be auto-locked upon determination that the employee has left the office for the day. In another embodiments, when a parent is determined to have left the house, the safe in their room may be auto-locked (or confirmed locked), which can ensure their children do not gain access to the materials in the safe.

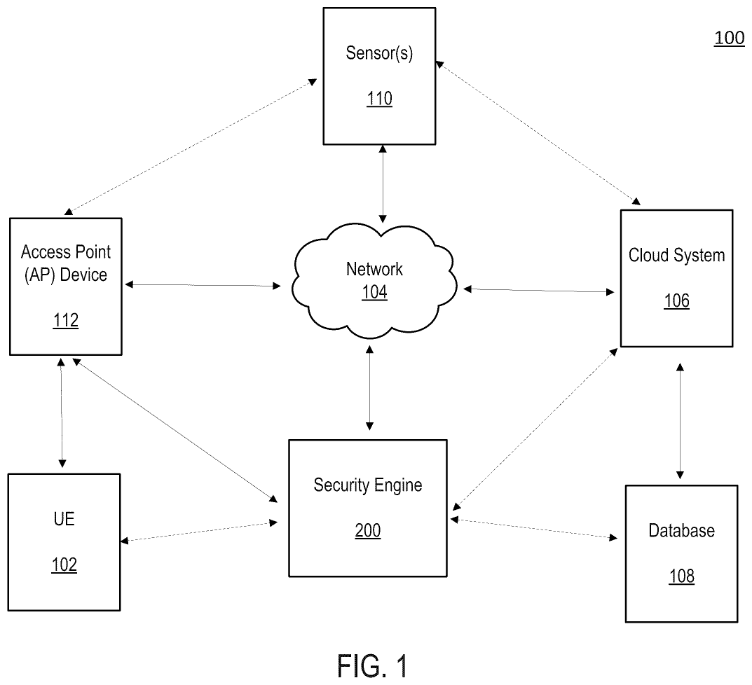

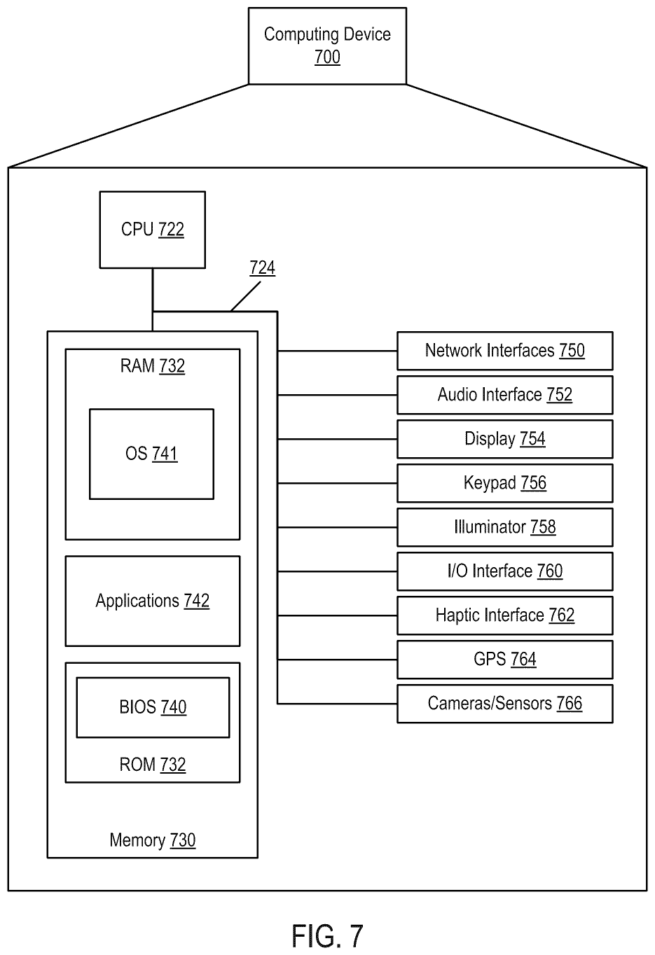

With reference to FIG. 1, system 100 is depicted which includes user equipment (UE) 102 (e.g., a client device, as mentioned above and discussed below in relation to FIG. 7), access point (AP) device 112, network 104, cloud system 106, database 108, sensors 110 and security engine 200. It should be understood that while system 100 is depicted as including such components, it should not be construed as limiting, as one of ordinary skill in the art would readily understand that varying numbers of UEs, AP devices, peripheral devices, sensors, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, IoT device, autonomous machine, and any other device equipped with a cellular or wireless or wired transceiver. For example, UE 102 can be a smart ring, which as discussed below in more detail, can enable the identification and/or collection of vitals of the wearing user. In some embodiments, such vitals can correspond to, but not be limited to, heart rate, heart rate variability (HRV), blood oxygen levels, blood pressure, hydration temperature, pulse, motion, sleep, and/or any other type of biometric for a person, or some combination thereof.

In some embodiments, peripheral device (not shown) can be connected to UE 102, and can be any type of peripheral device, such as, but not limited to, a wearable device (e.g., smart ring or smart watch), printer, speaker, sensor, and the like. In some embodiments, peripheral device can be any type of device that is connectable to UE 102 via any type of known or to be known pairing mechanism, including, but not limited to, WiFi, Bluetooth™, Bluetooth Low Energy (BLE), NFC, and the like. For example, the peripheral device can be a smart ring that connectively pairs with UE 102, which is a user's smart phone.

According to some embodiments, AP device 112 is a device that creates a wireless local area network (WLAN) for the location. According to some embodiments, the AP device 112 can be, but is not limited to, a router, switch, hub and/or any other type of network hardware that can project a WiFi signal to a designated area. In some embodiments, UE 102 may be an AP device.

According to some embodiments, sensors 110 (or sensor devices 110) can correspond to any type of device, component and/or sensor associated with a location of system 100 (referred to, collectively, as “sensors”). In some embodiments, the sensors 110 can be any type of device that is capable of sensing and capturing data/metadata related to a user and/or activity of the location. For example, the sensors 110 can include, but not be limited to, cameras, motion detectors, door and window contacts, heat and smoke detectors, passive infrared (PIR) sensors, time-of-flight (ToF) sensors, and the like.

In some embodiments, the sensors 110 can be associated with devices associated with the location of system 100, such as, for example, lights, smart locks, garage doors, smart appliances (e.g., thermostat, refrigerator, television, personal assistants (e.g., Alexa®, Nest®, for example)), smart rings, smart phones, smart watches or other wearables, tablets, personal computers, and the like, and some combination thereof. For example, the sensors 110 can include the sensors on UE 102 (e.g., smart phone) and/or peripheral device (e.g., a paired smart watch). In another example, sensors 110 can correspond to the sensors on a user's smart ring.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider, which has associated network resources hosted on the internet or private network (e.g., network 104), which enables (via engine 200) the security management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, sensors 110, and the services and applications provided by cloud system 106 and/or security engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

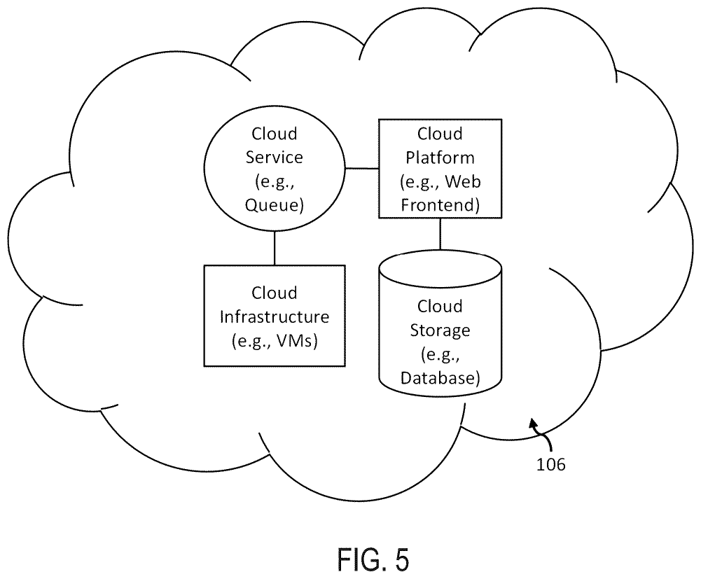

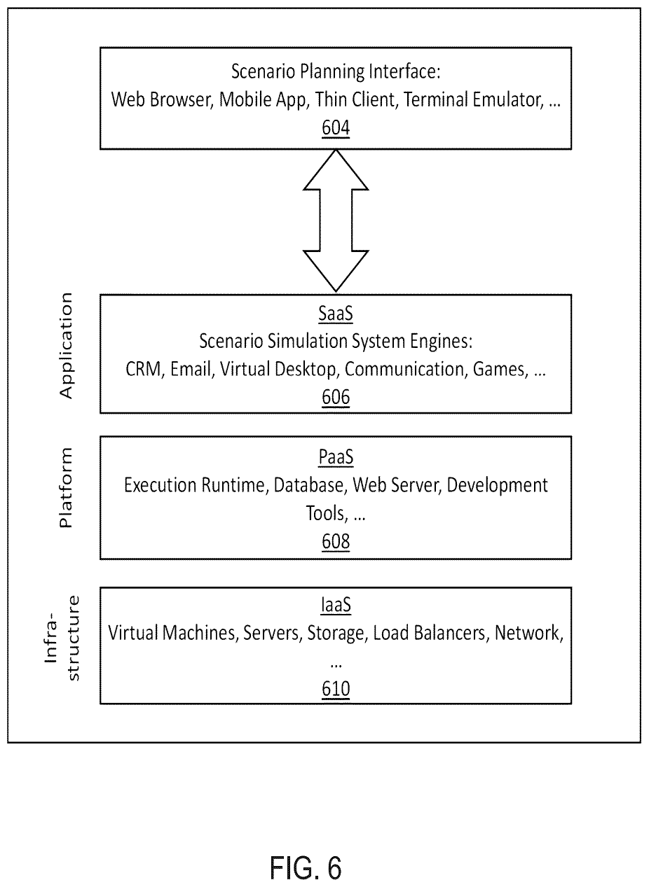

Turning to FIGS. 5 and 6, in some embodiments, the exemplary computer-based systems/platforms, the exemplary computer-based devices, and/or the exemplary computer-based components of the present disclosure may be specifically configured to operate in a cloud computing/architecture 120 such as, but not limiting to: infrastructure as a service (IaaS) 610, platform as a service (PaaS) 608, and/or software as a service (Saas) 606 using a web browser, mobile app, thin client, terminal emulator or other endpoint 604. FIGS. 5 and 6 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository

Security engine 200, as discussed above and further below in more detail, can include components for the disclosed functionality. According to some embodiments, security engine 200 may be a special purpose machine or processor, and can be hosted by a device on network 104, within cloud system 106, on AP device 112 and/or on UE 102. In some embodiments, engine 200 may be hosted by a server and/or set of servers associated with cloud system 106.

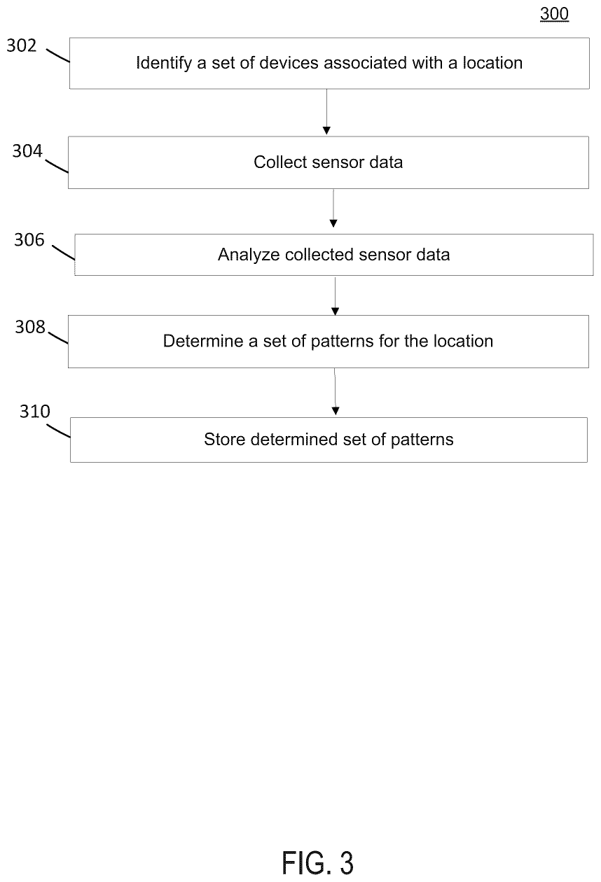

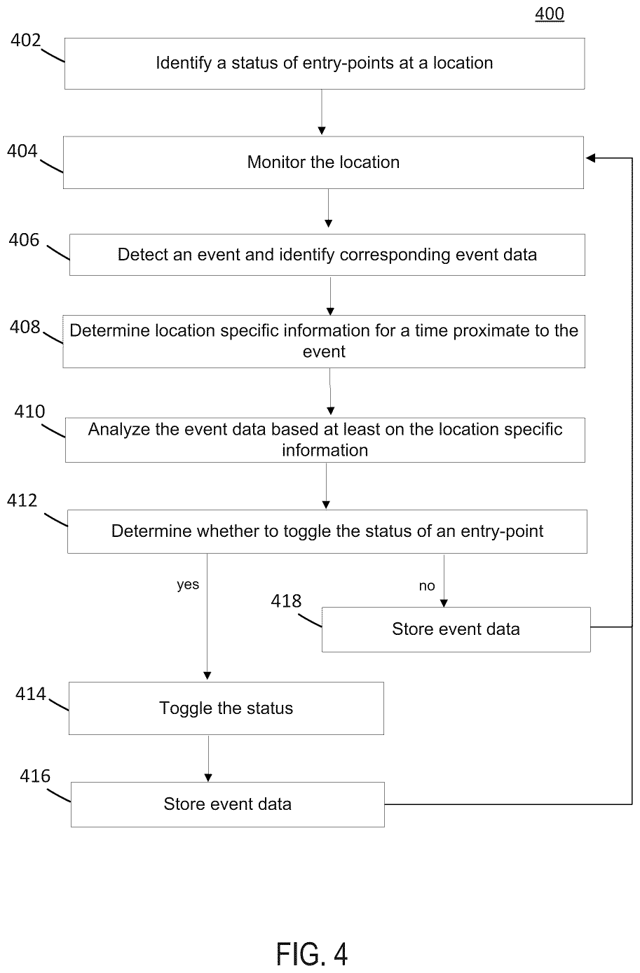

According to some embodiments, as discussed in more detail below, security engine 200 may be configured to implement and/or control a plurality of services and/or microservices, where each of the plurality of services/microservices are configured to execute a plurality of workflows associated with performing the disclosed security management. Non-limiting embodiments of such workflows are provided below in relation to at least FIGS. 3-4.

According to some embodiments, as discussed above, security engine 200 may function as an application provided by cloud system 106. In some embodiments, engine 200 may function as an application installed on a server(s), network location and/or other type of network resource associated with system 106. In some embodiments, engine 200 may function as application installed and/or executing on UE 102 and/or sensors 110 (and/or AP device 112, in some embodiments). In some embodiments, such application may be a web-based application accessed by AP device 112, UE 102 and/or devices associated with sensors 110 over network 104 from cloud system 106. In some embodiments, engine 200 may be configured and/or installed as an augmenting script, program or application (e.g., a plug-in or extension) to another application or program provided by cloud system 106 and/or executing on AP device 112, UE 102 and/or sensors 110.

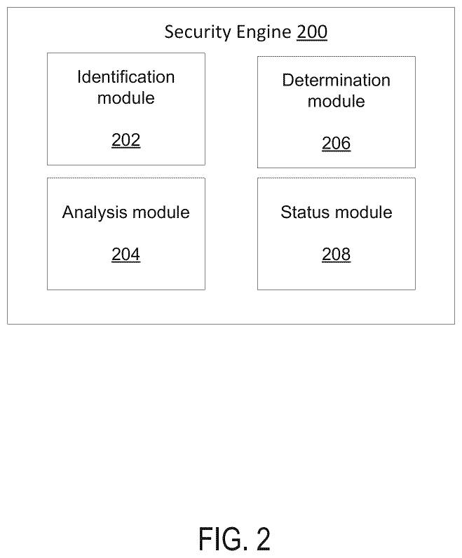

As illustrated in FIG. 2, according to some embodiments, security engine 200 includes identification module 202, analysis module 204, determination module 206 and status module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3, Process 300 provides non-limiting example embodiments for the disclosed security management framework. According to some embodiments, Process 300 provides non-limiting embodiments for determining user information and corresponding patterns of behavior for which the disclosed framework (e.g., via security engine 200) can control, manage and manipulate the operational status of a location.

According to some embodiments, Steps 302-304 of Process 300 can be performed by identification module 202 of security engine 200; Step 306 can be performed by analysis module 204; and Steps 308-310 can be performed by determination module 204.

According to some embodiments, Process 300 begins with Step 302 where a set of devices for a location are identified. According to some embodiments, the devices can be associated with any of the sensors 110, discussed above in relation to FIG. 1. For example, the devices can at least include security sensors (e.g., glass break, window contact, door contact, motion detection, and the like, as discussed above), and/or be associated with devices in/around the location (e.g., a user device, smart ring, and the like, as discussed supra). Additional, non-limiting examples of sensors and the types of collectable data are discussed above at least in relation to FIG. 1.

In some embodiments, Step 302 can further involve the identified set of devices being connected to engine 200. According to some embodiments, engine 200 can operate as a centralized “security panel” for a location. Thus, in some embodiments, Step 302 can involve the configuration of each identified devices and its pairing/connection with engine 200 and/or each other.

Accordingly, in some embodiments, with reference to FIG. 1, for example, sensors 110 can be paired with each other, with engine 200 and/or UE 102, which can be paired via connectivity protocols provided and/or enabled via engine 200. For example, a sensor 110 associated with a smart ring can be paired/connected with another sensor 110, engine 200 and/or UE 102 via WiFi or BLE technology. In some embodiments, the sensors 110 can be paired and/or connected with another sensor 110, engine 200 and/or UE 102 via a physical wire connection (e.g., fiber, ethernet, coaxial, and/or any other type of known or to be known wiring to hardwire a home for network connectivity for devices operating therein). In some embodiments, the sensors 110 can be paired/connected with another sensor 110, engine 200 and/or UE 102 via a cloud-to-cloud (C2C) connection (e.g., establish connection with a third party cloud, which connects with cloud system 106, for example). In some embodiments, the sensors 110 can be paired/connected via a combination of network capabilities, hard wiring and/or C2C. In some embodiments, the sensors 110 can be paired so as enable an extended reach of the sensor's configuration to detect specific types of events.

In Step 304, engine 200 can operate to trigger the identified devices to begin collecting sensor data. According to some embodiments, the sensor data can be collected continuously and/or according to a predetermined period of time or interval. In some embodiments, sensor data may be collected based on detected events. In some embodiments, type and/or quantity of sensor data may be directly tied to the type of sensor. For example, a window contact sensor may only collect sensor data when a window is opened (e.g., an open event, which can indicate, but is not limited to, the identity of the window, time of opening, time of closing, duration of opening, quantity of opening, and the like, or some combination thereof). In another non-limiting example, a gyroscope sensor on a user's smartphone and/or smart ring can detect when a user is moving, the type and/or metrics of such movements.

According to some embodiments, the sensor data can be derived from data collected from UE 102 (e.g., smart ring). As discussed above, the sensor data can provide biometrics or vitals for the user, which can include information related to, but are not limited to, heart rate, HRV, blood oxygen levels, blood pressure, hydration temperature, pulse, motion, sleep, and the like, or some combination thereof.

Accordingly, in some embodiments, the vitals, inclusive of the heart rate, HRV, blood pressure and blood oxygen level information, for example, can provide insights into a user's cardiovascular health, respiratory health and fitness level. In some embodiments, the vitals can further provide tracked information related to the user's physical activity, including, but not limited to, the number of steps taken, distance traveled, and calories burned, and the like. In some embodiments, the vitals can also include information related to a user's stress levels, which can include data related to the user's stress levels, for example. In some embodiments, the vitals can further provide data corresponding to the user's body temperature, which can provide, for example, information about their overall health and detect potential illnesses.

In some embodiments, the collected sensor data in Step 304 can be stored in database 108 in association with an identifier (ID) of a user, an ID of the location and/or an ID of an account of the user/location.

In Step 306, engine 200 can analyze the collected sensor data. According to some embodiments, engine 200 can implement any type of known or to be known computational analysis technique, algorithm, mechanism or technology to analyze the collected sensor data from Step 306.

In some embodiments, engine 200 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the sensor data, as discussed herein.

According to some embodiments, the AI/ML computational analysis algorithms implemented can be applied and/or executed in a time-based manner, in that collected sensor data for specific time periods can be allocated to such time periods so as to determine patterns of activity (or non-activity) according to a criteria. For example, engine 200 can execute a Bayesian determination for a predetermined time span, at preset intervals (e.g., a 24 hour time span, every 8 hours, for example), so as to segment the day according to applicable patterns, which can be leveraged to determine, derive, extract or otherwise activities/non-activities in/around a location.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 308, based on the analysis from Step 306, engine 200 can determine a set of patterns for a user(s) for the location and/or patterns for the location. According to some embodiments, the determined patterns are based on the computational AI/ML analysis performed via engine 200, as discussed above.

In some embodiments, the set of patterns can correspond to, but are not limited to, types of events, types of detected activity, a time of day, a date, type of user, duration, amount of activity, quantity of activities, sublocations within the location (e.g., rooms in the house, for example), and the like, or some combination thereof. Accordingly, the patterns can be specific to a user, and/or specific to the location.

For example, a specified pattern of activity for a user may correspond to a specific day of the week, and a specific time. For example, a pattern may correspond to “morning routine” of a user from 6 AM to 7:30 AM, on a Monday, whereby the user is determined as waking up from sleep, checking their phone, walking into the kitchen to make coffee, then moving back to their bedroom to get dressed, and then leave for work out of the front door of the house. The pattern can correspond to and/or indicate specific routes within the location (e.g., which rooms are entered and exited, hallways used, and in which order, for example). Thus, as discussed below at least in relation to FIG. 4, the disclosed framework can automatically determine to auto-lock the front door upon the user's exit.

In Step 310, engine 200 can store the determined set of patterns in database 108, in a similar manner as discussed above. According to some embodiments, Step 310 can involve creating a data structure associated with each determined pattern, whereby each data structure can be stored in a proper storage location associated with an identifier of the user/location, as discussed above.

In some embodiments, a pattern can comprise a set of events, which can correspond to an activity and/or non-activity (e.g., exercising in the house, cleaning the dishes, sleeping, and the like, for example). The patterns can also include information related to which entry-points are to be engaged/dis-engaged (e.g., opened/closed based on the set of events). In some embodiments, the pattern's data structure can be configured with header (or metadata) that identifies a user and/or the location, and/or a time period/interval of analysis (as discussed above); and the remaining portion of the structure providing the data of the activity/non-activity and status of entry-points during such sequence(s). In some embodiments, the data structure for a pattern can be relational, in that the events of a pattern can be sequentially ordered, and/or weighted so that the order corresponds to events with more or less activity.

In some embodiments, the structure of the data structure for a pattern can enable a more computationally efficient (e.g., faster) search of the pattern to determine if later detected events correspond to the events of the pattern, as discussed below in relation to at least Process 400 of FIG. 4. In some embodiments, the data structures of patterns can be, but are not limited to, files, arrays, lists, binary, heaps, hashes, tables, trees, and the like, and/or any other type of known or to be known tangible, storable digital asset, item and/or object.

According to some embodiments, the sensor data can be identified and analyzed in a raw format, whereby upon a determination of the pattern, the data can be compiled into refined data (e.g., a format capable of being stored in and read from database 108). Thus, in some embodiments, Step 310 can involve the creation and/or modification (e.g., transformation) of the sensor data into a storable format.

In some embodiments, as discussed below, each pattern (and corresponding data structure) can be modified based on further detected behavior, as discussed below in relation to Process 400 of FIG. 4.

Turning to FIG. 4, Process 400 provides non-limiting example embodiments for the deployment and/or implementation of the disclosed security management framework.

According to some embodiments, Steps 402-404 and 414-418 of Process 400 can be performed by status module 208 of security engine 200; Steps 406-408 and 412 can be performed by determination module 206; and Step 410 can be performed by analysis module 204.

According to some embodiments, Process 400 begins with Step 402 where engine 200 identifies a status of at least a portion of the entry-points at a location (e.g., a predefined physical/geographic location (e.g., a house or building), as discussed above). For example, Step 402 can involve the determination of which doors are currently opened, which windows are closed, if the garage doors are open, and the like. Accordingly, in some embodiments, the status can include information indicating a state of each entry-point, which can indicate whether the entry-point is in an open state, unlocked state, closed state, locked state, and the like, or some combination thereof. In some embodiments, an entry-point state can be a sub-state of another state—for example, if a door is unlocked, a sub-state may be that the door is open (and vice versa).

In some embodiments, Step 402 operates to determine a baseline (e.g., an initial and/or current status of each entry-point) for the subsequent monitoring performed in Step 404. In some embodiments, Step 402 can involve engine 200 pinging each of the APIs of the smart devices associated with each entry-point, such that in response, engine 200 can receive data indicating the status of the entry-point (e.g., whether the entry-point is open, closed, locked and/or unlocked, and the like). For example, if a door is open, the smart device (e.g., smart lock) of the door is in an opened (and unlocked) state.

In Step 404, engine 200 can monitor the location to detect, determine or otherwise identify activity related to user movement (or non-movement) at the location and/or status changes of each entry-point. In some embodiments, engine 200 can monitor the location continuously, and/or according to a predetermined time interval. In some embodiments, the monitoring of the location can be performed via the location's sensors in a similar manner as discussed above at least in relation to Step 306 of Process 300, discussed supra. In some embodiments, the monitoring can involve periodically pinging each or a portion of the sensors at the location, and awaiting a reply. In some embodiments, the monitoring can involve push and/or fetch protocols to collect sensor data from each sensor.

In Step 406, based on the monitoring of the location, engine 200 can detect an event. In some embodiments, the detection of the event can involve a sensor or sensors at the location (e.g., that are connected via Process 300, discussed supra) detecting sensor data for an event, and electronically communicating that sensor data via the established connection with engine 200, as discussed above.

In some embodiments, an event (and associated event data) can correspond to activity at the location (e.g., a user moving, an item moving, a door opening, and the like). In some embodiments, the activity may have to be performed according to a criteria including, but not limited to, a time, a date, a particular size, movements for a predetermined period of time (e.g., 3 seconds), movements at a certain speed (e.g., velocity and/or acceleration), movements at certain angles and/or trajectories, a location within the location (e.g., a sub-location), and the like, or some combination thereof. In some embodiments, the activity data can further and/or alternatively provide information related to vitals of the user(s) at the location (as collected via a smart ring), which can be performed in a similar manner discussed supra.

By way of a non-limiting example, an event can correspond to a user falling asleep at night in their bedroom. For example, the event data can include information related to, but not limited to, a time, type of non-movement, location within the house, user identity, heart rate, and the like. For example, the time can correspond to, but is not limited to, when the user entered their bedroom, and when their heart rate dropped below a threshold level associated with a person falling asleep (e.g., or that specific person falling asleep, as indicated by the determined patterns discussed above respective to Process 300).

In some embodiments, an event can be detected based on the learned patterns of the user, as discussed above. That is, for example, engine 200 can determine that the user typically falls asleep at a certain time on specific days, and upon detecting that time and day are occurring (e.g., it is 10 PM on a Monday, for example), engine 200 can collect this information as event data (e.g., the time, day and user identifier, for example). Moreover, in some embodiments, upon detection of such event, engine 200 can cause the sensors 110 (e.g., in the user bedroom, associated with UE 102 (e.g., smart ring, for example)) to collect and/or monitor vitals about the user. In some embodiments, therefore, the event data can be data provided by and/or associated with a known/stored pattern.

Accordingly, in some embodiments, Step 408 can further involve searching for and identifying a specific stored pattern based on the detected event. The stored pattern can correspond to previously observed and/or determined behavior of a user that corresponds to the event (e.g., a type of event, time of the event, date of the event, user(s) involved in the event, actions in the event, and the like or some combination thereof). For example, since the event occurs at 10 PM, this can be determined to correspond to the “bedtime routine” pattern of the user.

In Step 408, engine 200 can determine location specific information for a time proximate to the event. According to some embodiments, the location specific information can include, but is not limited to, a user's ID, a type of user (e.g., adult, child, and the like), biometrics of the user, demographics of the user, position within the location (e.g., where in the house the user is, for example), movements of the user, which sensors are triggered by the event, climate in the location and/or outside the location, ID and/or number of other occupants at the location, and the like, or some combination thereof. Accordingly, the environment of the location can be indicated, which can provide indicators as to which devices are being used (e.g., watching television, listening to the radio, and the like), whether lights are on, and the like.

Thus, the location specific information provides data related to a current actions, environment and/or surroundings of the user in relation to when and/or where the event is/has occurred (e.g., what the user is doing and where they are doing it at the location upon detection of the event, for example).

According to some embodiments, the time proximate can be a threshold period of time before and/or after the event. For example, 30 seconds before and/or after the event, which can enable a better understanding of the user's current movements and/or trajectory of their movements (e.g., where they are headed and/or if they have turned around, for example). In some embodiments, the time proximate may be based on settings provided by a user, an administrator, and/or dynamically determined based on a type of event and/or movements, and the like.

Continuing with the above non-limiting example, the event can correspond to a user falling asleep at night—for example, engine 200 detects that the time is 10 PM on a Monday, and the location specific information can indicate, for example, the ID of the user, body temperature of the user, heart rate of the user, temperature in the house, whether the user is in bed (and/or is getting into bed), whether television in the room is on, if the user has or is using their smart phone, location of their phone to the user's current position, and the like.

In Step 410, engine 200 can analyze the event data based at least on the location specific information and the stored, associated behavior pattern(s). Such analysis can enable, via Step 412, a determination as to whether to toggle the status of an entry-points(s) (or at least present the user with an option to toggle the operation mode, as discussed below). As discussed above, Step 402 involved the identification of the location's entry-points, and in Step 412, engine 200 can determine whether an “unsecured” entry-point is to be “secured.”

According to some embodiments, Steps 410-412 can involve engine 200 analyzing the detected event data by comparing the event data and location specific information to the retrieved pattern data for that location and/or user, as discussed above. In some embodiments, such analysis and determination can be performed in a similar manner as discussed above at least in relation to Steps 306-308 of Process 300 of FIG. 3.

In some embodiments, engine 200 can perform the comparison (and determination of Step 412) based on a similarity analysis, whereby an activity and/or correlation to known activities can be analyzed to determine whether the event data is substantially similar, based on a similarity threshold, to known activities. According to some embodiments, engine 200 can implement any known or to be known similarity algorithm, technique or mechanism to perform such similarity determination, including, but not limited to, feature vector analysis, decision trees, boosting, support-vector machines, neural networks, nearest neighbor algorithms, Naive Bayes, random forests, logistic regression, and the like.

For example, an event can be translated to an n-dimensional feature vector, whereby a comparison between nodes of the feature vector of the event may be compared to nodes of feature vectors of the determined patterns for the user/location. Should the similarity values be at or above a threshold, then a similar event may have been detected.

By way of a non-limiting example, considering the above “bedtime routine” example, if the user is determined to be not-moving (and/or have a heart rate commensurate with that user sleeping) in a threshold satisfying related to known sleeping of the user as provided by the stored pattern of the “bedtime routine,” then the comparison can yield a determination that the user is following their routine and engine 200 can generate and communicate computerized instructions to the devices/APIs of “unsecured” the entry-points to have them “secured.” For example, upon detecting that the user is asleep, engine 200 can identify which doors/windows are open (and should be closed), whereby engine 200 can connect with the smart devices of such doors/windows and cause them to be closed and/or locked.

Therefore, in some embodiments, Step 412 can involve engine 200 determining whether a toggle to the current status of an entry-point(s) should/can occur.

In some embodiments, when Step 412's determination involves identification that the user is not acting according to a known pattern, engine 200 can proceed from Step 412 to Step 418, where it is determined to not toggle the status. For example, the user is in their bedroom, but the lights are on and the user is reading the news on their smart phone. Thus, while the vitals may indicate a heart rate commensurate a heart rate of sleeping, the other sensors in the home may provide data indicating otherwise. Thus, in Step 418, the event data (and in some embodiments, location specific information) can be stored in a similar manner as discussed above.

In some embodiments, such event data (and in some embodiments, location specific information) can be utilized to update an existing pattern and/or form a new pattern for the user/location. In some embodiments, upon a similar type of event data being identified at least a threshold number of times, engine 200 can register the detected event as a new pattern which can be leveraged to automate how engine 200 controls the security of the location. Such new pattern can be generated via Process 300, as discussed above.

In some embodiments, when Step 412's determination involves identification that the user is acting in a scheduled manner according to the known pattern, engine 200 can proceed from Step 412 to Step 418. In Step 418, engine 200 can perform a toggle operation, whereby the status of each open and/or unlocked entry-point (from Step 402) can be automatically changed, as discussed herein. For example, open doors can be closed and locked, and closed doors can be locked. In some embodiments, the toggling can be set to occur at a time proximate to the event (e.g., a buffer of 30 seconds to ensure accuracy as continued monitoring can occur during such buffer time to provide a confirmation indication to the engine 200).

In some embodiments, Step 414 can include sending a request to the user (and/or another user associated with the location (e.g., another known occupant, as determined from Process 300)), whereby the user can authorize, decline, modify and/or snooze the toggle operation. In some embodiments, such request can be any type of message, and can include any type of content including, but not limited to, audio, text, video, images, and the like. For example, the request can be provided via an SMS message to the user's smartphone. In another example, the request can be audibly rendered via a connected smart speaker. And, in another non-limiting example, a haptic effect can be provided on the smart ring of a user, which can be accepted and/or rejected via a specific movement and/or quantity of movement as detected by the smart ring's gyroscope (e.g., shaking your hand, closing your fist, and the like, can correspond to acceptance or denial of a toggle request).

And, in Step 416, the event data (and in some embodiments, location specific information) can be stored in database 108, in a similar manner as discussed above. In some embodiments, such stored event data (and in some embodiments, location specific information) can also be used to fine-tune and/or update the ML/AI algorithms utilized by engine 200, and/or to update the known pattern used for the comparison (as discussed above in relation to Steps 406-412). In some embodiments, such storage can involve the creation of a new data pattern data structure; and in some embodiments, such storage can involve the modification of an existing pattern data structure to include the updated event data (e.g., update the “bedtime routine” data structure”, for example). In some embodiments, the event data can be further utilized to train engine 200 to determine corresponding events for future events.

Accordingly, after Step 416 and Step 418, engine 200 may then continue monitoring the location. In some embodiments, the monitoring does not stop upon detection of an event, but continues running in the backend, while certain modules of engine 200 analyze each detected event.

According to some embodiments, a location can have a dedicated engine 200 model so that the security and safety protocols applied to the location can be specific to the events and patterns learned and detected at that location. In some embodiments, the model can be specific for a user or set of users (e.g., users that live at a certain location (e.g., a house), and/or are within a proximity to each other (e.g., live on the same street, for example)).

Thus, as discussed herein, the disclosed framework enables a location-based and enable security framework monitor and learn the habits of occupants at a location, and tailor the enablement of the security operations to specific activities associated with such habits and the schedules of the occupants.

FIG. 7 is a schematic diagram illustrating a client device showing an example embodiment of a client device that may be used within the present disclosure. Client device 700 may include many more or less components than those shown in FIG. 7. However, the components shown are sufficient to disclose an illustrative embodiment for implementing the present disclosure. Client device 700 may represent, for example, UE 102 discussed above at least in relation to FIG. 1.

As shown in the figure, in some embodiments, Client device 700 includes a processing unit (CPU) 722 in communication with a mass memory 730 via a bus 724. Client device 700 also includes a power supply 726, one or more network interfaces 750, an audio interface 752, a display 754, a keypad 756, an illuminator 758, an input/output interface 760, a haptic interface 762, an optional global positioning systems (GPS) receiver 764 and a camera(s) or other optical, thermal or electromagnetic sensors 766. Device 700 can include one camera/sensor 766, or a plurality of cameras/sensors 766, as understood by those of skill in the art. Power supply 726 provides power to Client device 700.

Client device 700 may optionally communicate with a base station (not shown), or directly with another computing device. In some embodiments, network interface 750 is sometimes known as a transceiver, transceiving device, or network interface card (NIC).

Audio interface 752 is arranged to produce and receive audio signals such as the sound of a human voice in some embodiments. Display 754 may be a liquid crystal display (LCD), gas plasma, light emitting diode (LED), or any other type of display used with a computing device. Display 754 may also include a touch sensitive screen arranged to receive input from an object such as a stylus or a digit from a human hand.

Keypad 756 may include any input device arranged to receive input from a user. Illuminator 758 may provide a status indication and/or provide light.

Client device 700 also includes input/output interface 760 for communicating with external. Input/output interface 760 can utilize one or more communication technologies, such as USB, infrared, Bluetooth™, or the like in some embodiments. Haptic interface 762 is arranged to provide tactile feedback to a user of the client device.

Optional GPS transceiver 764 can determine the physical coordinates of Client device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS or the like, to further determine the physical location of client device 700 on the surface of the Earth. In one embodiment, however, Client device may through other components, provide other information that may be employed to determine a physical location of the device, including for example, a MAC address, Internet Protocol (IP) address, or the like.

Mass memory 730 includes a RAM 732, a ROM 734, and other storage means. Mass memory 730 illustrates another example of computer storage media for storage of information such as computer readable instructions, data structures, program modules or other data. Mass memory 730 stores a basic input/output system (“BIOS”) 740 for controlling low-level operation of Client device 700. The mass memory also stores an operating system 741 for controlling the operation of Client device 700.

Memory 730 further includes one or more data stores, which can be utilized by Client device 700 to store, among other things, applications 742 and/or other information or data. For example, data stores may be employed to store information that describes various capabilities of Client device 700. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 700.

Applications 742 may include computer executable instructions which, when executed by Client device 700, transmit, receive, and/or otherwise process audio, video, images, and enable telecommunication with a server and/or another user of another client device. Applications 742 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying, by a device, a status of an entry-point to a location, the entry-point associated with a smart device at the location, the status comprising information indicating the smart device is in an unlocked state;
monitoring, by the device, activity data associated with a user at the location, the activity data indicating movement or non-movement of the user at the location and a time of the movement or non-movement;
analyzing, by the device, the activity data based on a known pattern of activity of the user, the known pattern of activity corresponding to the time;
determining, by the device, to toggle the status of the entry-point based on the analysis; and
causing, by the device, the smart device of the entry-point to automatically change to a locked state based on the toggle determination.

2. The method of claim 1, wherein the unlocked state further comprises information indicating that the entry-point is in an open state.

3. The method of claim 2, further comprising:
causing, based on the determination, the entry-point to close via the smart device.

4. The method of claim 1, further comprising:
collecting the activity data via a set of sensor devices at the location, wherein the activity data comprises information related to at least one biometrics of the user, position within the location, identity of the user, a type of user and an environment of the location.

5. The method of claim 4, wherein the set of sensor devices at the location at least includes a smart ring of the user.

6. The method of claim 4, wherein the biometrics of the user include information related to at least one of heart rate, heart rate variability (HRV), blood oxygen levels, blood pressure, hydration temperature, pulse, motion and sleep.

7. The method of claim 1, further comprising:
determining, based on the analysis, to enable the entry point at the identified status, wherein the device continues monitoring the location without performing the toggle of the smart device.

8. The method of claim 1, further comprising:
identifying a set of sensors associated with the location;
collecting sensor data from each of the set of sensors;
analyzing, via an application, the collected sensor data;
determining, via the application, a set of patterns of activity for the user at the location; and
storing, in a database, the set of patterns of activity.

8. The method of claim 8, wherein the known pattern of activity is identified from the stored determined pattern of activity.

9. The method of claim 1, wherein the location comprises at building, wherein the building is a home of the user.

10. The method of claim 1, wherein the entry-point corresponds at least one of a door and window of the location.

11. A device comprising:
a processor configured to:
identify a status of an entry-point to a location, the entry-point associated with a smart device at the location, the status comprising information indicating the smart device is in an unlocked state;
monitor activity data associated with a user at the location, the activity data indicating movement or non-movement of the user at the location and a time of the movement or non-movement;
analyze the activity data based on a known pattern of activity of the user, the known pattern of activity corresponding to the time;
determine to toggle the status of the entry-point based on the analysis; and
cause the smart device of the entry-point to automatically change to a locked state based on the toggle determination.

12. The device of claim 11, wherein the unlocked state further comprises information indicating that the entry-point is in an open state.

13. The device of claim 12, wherein the processor is further configured to:
cause, based on the determination, the entry-point to close via the smart device.

14. The device of claim 11, wherein the processor is further configured to:
collect the activity data via a set of sensor devices at the location, wherein the activity data comprises information related to at least one biometrics of the user, position within the location, identity of the user, a type of user and an environment of the location, wherein the set of sensor devices at the location at least includes a smart ring of the user.

15. The device of claim 11, wherein the processor is further configured to:
identify a set of sensors associated with the location;
collect sensor data from each of the set of sensors;
analyze, via an application, the collected sensor data;
determine, via the application, a set of patterns of activity for the user at the location; and
store, in a database, the set of patterns of activity, wherein the known pattern of activity is identified from the stored determined pattern of activity.

16. A non-transitory computer-readable storage medium tangibly encoded with computer-executable instructions that when executed by a device, perform a method comprising:
identifying, by the device, a status of an entry-point to a location, the entry-point associated with a smart device at the location, the status comprising information indicating the smart device is in an unlocked state;
monitoring, by the device, activity data associated with a user at the location, the activity data indicating movement or non-movement of the user at the location and a time of the movement or non-movement;
analyzing, by the device, the activity data based on a known pattern of activity of the user, the known pattern of activity corresponding to the time;
determining, by the device, to toggle the status of the entry-point based on the analysis; and
causing, by the device, the smart device of the entry-point to automatically change to a locked state based on the toggle determination.

17. The non-transitory computer-readable storage medium of claim 16, wherein the unlocked state further comprises information indicating that the entry-point is in an open state.

18. The non-transitory computer-readable storage medium of claim 17, further comprising:
causing, based on the determination, the entry-point to close via the smart device.

19. The non-transitory computer-readable storage medium of claim 16, further comprising:
collecting the activity data via a set of sensor devices at the location, wherein the activity data comprises information related to at least one biometrics of the user, position within the location, identity of the user, a type of user and an environment of the location, wherein the set of sensor devices at the location at least includes a smart ring of the user.

20. The non-transitory computer-readable storage medium of claim 16, further comprising:
identifying a set of sensors associated with the location;
collecting sensor data from each of the set of sensors;
analyzing, via an application, the collected sensor data;
determining, via the application, a set of patterns of activity for the user at the location; and
storing, in a database, the set of patterns of activity, wherein the known pattern of activity is identified from the stored determined pattern of activity.
